(19) United States
(12) Patent Application Publication
(10) Pub. No.: US 2018/0001891 A1
(43) Pub. Date: Jan. 4, 2018

(54) DEVICE AND METHOD FOR STABILIZING A MOTOR VEHICLE

(71) Applicant: Continental Teves AG & Co. oHG, Frankfurt (DE)

(72) Inventors: Peter Lauer, Karben (DE); Thomas Raste, Oberursel (DE); Alfred Eckert, Mainz-Hechtsheim (DE)

(73) Assignee: Continental Teves AG & Co. oHG, Frankfurt (DE)

(21) Appl. No.: 15/708,545

(22) Filed: Sep. 19, 2017

Related U.S. Application Data
(63) Continuation of application No. PCT/EP2016/056009, filed on Mar. 18, 2016.

(30) Foreign Application Priority Data
Mar. 20, 2015 (DE) 10 2015 205 089.0

(51) Int. Cl. B60W 30/12; G08G 1/16; B60W 30/18; B60W 10/18; B60W 10/20; B60W 30/045

(52) U.S. Cl. CPC B60W 30/12; B60W 10/20; B60W 30/045; B60W 30/18145; B60W 10/18; G08G 1/167; B60W 2520/14; B60W 2550/146; B60W 2710/20; B60W 2720/14; B60W 2720/20; B60W 2720/24; B60W 2710/18

(57) ABSTRACT

A device for stabilizing a vehicle after a collision against a lateral carriageway boundary, includes a lane recognition system, with which information relating to the course of the lane is determined or detected. A collision detection unit identifies a collision of the vehicle against the lateral lane carriageway boundary on the basis of signals from at least one sensor or on the basis of a driving state variable. The device also includes a steering actuator for steering a steering system and a brake actuator for controlling one or more wheel brakes. A target path determination unit determines a target path for the vehicle on the basis of the course of the lane determined or detected before or at the time of the collision. A controller guides the vehicle onto the target path and/or stabilizes the vehicle via a steering intervention and/or individual wheel brake interventions.

### CROSS REFERENCE TO RELATED APPLICATIONS

This application claims the benefit of International application No. PCT/EP2016/056009, filed Mar. 18, 2016, which claims priority to German Application No. 10 2015 205 089.0, filed Mar. 20, 2015, each of which is hereby incorporated by reference.

### TECHNICAL FIELD

The technical field relates to a device and a method for stabilizing a motor vehicle, in particular following a collision against a lateral carriageway boundary.

### BACKGROUND

German patent publication No. DE 10 2012 107 188 A1 discloses a method for activating protective measures following a lateral collision. The protective measures comprise, for example, automatic braking, stabilization of the driving direction by individual braking interventions and a damping of the steering movement.

Such a method has the disadvantage that, in every case, the movement of the vehicle is influenced in the same way, such that the vehicle ends up moving in a straight line, which may potentially not suit the circumstances. The automatic braking and damping of the steering can lead to worse maneuverability by the driver in which case, where relevant, further accidents can no longer be avoided.

As such, it is desirable to present a device and method to support the driver following a collision against a lateral carriageway boundary. In addition, other desirable features and characteristics will become apparent from the subsequent summary and detailed description, and the appended claims, taken in conjunction with the accompanying drawings and this background.

### SUMMARY

According to one exemplary embodiment, a device for stabilizing a motor vehicle includes a driving lane recognition system with which information relating to the course of the driving lane is determined or detected. The device includes a collision detection unit which identifies a collision of the vehicle, in particular against the lateral carriageway boundary, by signals from at least one sensor or on the basis of a driving state variable. The device further includes a target path determination unit, which determines a target path for the vehicle. The device also includes a controller which guides the vehicle along the target path and/or effects a stabilization of the motor vehicle by means of a steering intervention and/or by braking interventions on individual wheels.

The device may also include an electronically controllable steering actuator for activating a steering system and an electronically controllable brake actuator for activating one or a number of wheel brakes.

By determining a target path, which can take into account available information about the motor vehicle's environment, it is ensured that the vehicle is controlled appropriately according to the conditions.

An exemplary embodiment of a method for stabilizing a motor vehicle, in particular following a collision with a lateral carriageway boundary, is also disclosed. The method includes determining or identifying information relating to the course of a driving lane, in particular relating to a curve in the course of the driving lane. The method further includes detecting a collision of the vehicle, in particular against the lateral carriageway boundary, by signals from at least one sensor, or on the basis of a driving state variable. The method also includes determining a target path for the vehicle, in particular on the basis of the course of the driving lane as determined or detected before, or at the time of, the collision. The method further includes guiding the vehicle onto the target path and/or stabilizing the vehicle by means of a controller, by carrying out a steering intervention and/or braking interventions on individual wheels.

In order to detect a collision, a lateral acceleration or a longitudinal acceleration, or the signal from a lateral acceleration sensor or the signal from a longitudinal acceleration sensor, may be used.

In order to detect a collision, a motor vehicle speed may be used.

The controller may realized as a state controller, for example an LQ controller (linear quadratic controller).

The target path may be determined for the vehicle on the basis of the course of the driving lane as determined or detected before, or at the time of, the collision.

The driving lane recognition system may continuously record a curve or the course of a curve in the course of the driving lane. The curve or the course of the curve is advantageously determined over a given distance in advance, i.e., ahead of the vehicle.

The curve of the carriageway is a variable which allows as simple and quick a calculation of a suitable target path as possible. Determination of the course of the curve in advance has the advantage that the necessary information is always available, and also, for example, if the sensor system has been damaged by the collision, a regulation may nevertheless be carried out using the already available information.

The controller may regulate a sideslip angle and/or a yaw rate and/or a deviation of a yaw angle and/or a transverse displacement of the vehicle.

A deviation of the yaw angle and/or a transverse deviation between actual and target paths or actual and target values may be determined on the basis of the target path and actual values of the drive state variable.

According to one exemplary embodiment of the device or according to one exemplary embodiment of the method, a current value of the sideslip angle and/or the vehicle speed and/or the steering angle and/or the yaw rate and/or the lateral acceleration is determined and taken into account for the actual path.

Advantageously, the sideslip angle and/or the yaw angle are determined by integration. The sideslip angle and/or the yaw angle may also be determined on the basis of a model. The sideslip angle and/or the yaw angle may further be determined by integration using a model with the aid of a measured yaw rate, a lateral acceleration and a vehicle speed.

The controller may weight the stabilization of the vehicle or the guidance of the vehicle onto the target path in accordance with the actual value of the sideslip angle.

While controlling, the controller may perform a weighting of the state variables in accordance with the actual value of the sideslip angle.

Where sideslip angles are greater, in absolute terms, than a prescribed sideslip angle limit value, the controller carries out a sideslip angle regulation. The sideslip angle limit value may be approximately 10°.

When a collision is detected, the determined or detected course of the driving lane may be saved as the target path for the vehicle, and this target path is made available to the controller as an input value.

The controller may determine a steering angle and/or a yaw moment on the basis of a vehicle model.

The steering intervention, in particular the activation of the steering actuator, may occur in accordance with the determined steering angle.

The braking intervention(s) on individual wheels, in particular the activation of the brake actuator, may occur in accordance with the determined yaw moment.

According to a one exemplary embodiment, a steering moment is determined from the steering angle. The activation of the steering actuator may occur in accordance with the determined steering moment. Advantageously, the steering moment is determined from the steering angle with a controller, for example a PID controller.

According to one exemplary embodiment, braking pressures for the wheel brakes are determined from the yaw moment. The activation of the brake actuator may occur in accordance with the braking pressures.

The regulation may be brought to an end by the controller when a prescribed duration for the regulation has elapsed. The prescribed duration may amount to a few seconds, for example approximately 5 seconds.

Alternatively or in addition, control is brought to an end by the controller if, in absolute terms, the steering angle falls below a prescribed steering angle threshold value.

Alternatively or in addition, the regulation is brought to an end by the controller when the steering angle speed falls, in absolute terms, below a prescribed steering angle speed threshold value. The regulation may be brought to an end by the controller when the steering angle speed falls, in absolute terms, below a prescribed steering angle speed threshold value for a prescribed duration. The prescribed duration may amount to approximately 500 ms.

According to one exemplary embodiment, the braking interventions on individual wheels are carried out so that a predetermined overall deceleration of the vehicle is achieved. The overall deceleration is may be prescribed or predetermined by another system or another function, for example a multi-collision braking function. An overall deceleration of at most approximately 0.5 g is thereby achieved.

The braking interventions on individual wheels may be carried out so that, by redistributing the braking pressures, the overall pressure remains the same and a yaw moment is produced by lateral variations. An overall rise in pressure may occur only if the pressure on one side (of the vehicle) is smaller than a predetermined value, for example approximately 5 bar, and a greater yaw moment is requested by the controller.

The controller may control an active steering system in such a way that steering moments are applied which support the driver in stabilizing the vehicle and/or guiding the vehicle onto the target path.

A driver-independent build-up of brake force in at least one wheel brake may be effected by the controller in such a way that the vehicle is stabilized and/or guided onto the target path.

The driving lane recognition system may determine or detect information relating to the course of the driving lane for at least a predetermined distance in front of the vehicle. The curve may be determined in advance over a distance of approximately 150 m.

The driving lane recognition system may be based on at least one camera or on at least one GPS (Global Positioning System) or on at least one road map.

The device may include an electric power steering system which may, in particular, be controlled via a torque interface.

The device may include an electrically controllable pressure source for building up brake pressure for hydraulically operated wheel brakes.

The device and method offer the advantage that after a collision with a crash barrier the vehicle is stabilized and/or guided onto a safe route until the driver is able to control the vehicle himself.

Further exemplary embodiments are disclosed in the sub-claims and the following description by means of figures.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows a schematically depicted exemplary device or a schematic flow diagram for illustrating an exemplary method;

FIG. 2 shows a schematic depiction of exemplary driving state variables for an exemplary model for lateral control; and

FIG. 3 schematically shows an exemplary controller structure.

### DETAILED DESCRIPTION

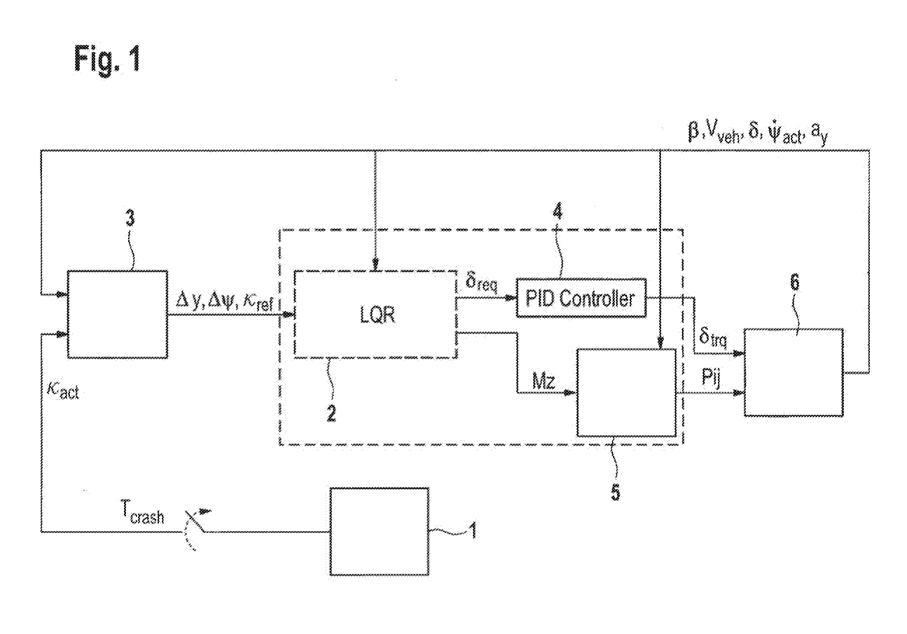

FIG. 1 depicts a schematically depicted exemplary device or a schematic flow diagram for illustrating an exemplary method.

By way of example, a driving lane recognition system 1 may be seen in FIG. 1 with which information relating to the course of the driving lane, for example in the form of the curve κ_{act}, may be determined or detected.

Furthermore a collision detection unit is provided which detects a collision of the vehicle against, for example, the lateral carriageway boundary, by means of signals from at least one sensor or on the basis of a driving state variable. By way of example, a collision is detected when the lateral acceleration sensor (a_{y}) or longitudinal acceleration sensor (aₓ) exceeds a certain limit value which would not occur in the course of an actual driving maneuver (e.g., 2 g), and the vehicle speed Vᵥₑₕ exceeds an appropriate limit value (e.g., 30 km/h).

Further, there is a target path determination unit which determines a target path for the vehicle, for example in the form of a curve or the course of a curve κ_{ref}. By way of example, the target path is determined by means of the course of the driving lane as determined or detected before or at the time T_{crash} of the collision.

After the collision, the driving lane recognition system 1 may be damaged or inoperative so that the regulation by the controller 2 is based on the curve as determined at the time of the collision and as saved on impact.

The controller 2 is, by way of example, realized as a state controller, for example an LQR (linear quadratic controller). The controller effects a guiding of the vehicle onto the target path and/or a stabilization of the vehicle by means of a steering intervention and/or by braking interventions on individual wheels. The controller 2 is based on a vehicle model.

By way of example, the vehicle 6 has an electrically controllable steering actuator for controlling a steering system, and an electrically controllable brake actuator for controlling one or a number of wheel brakes.

By way of example, a comparison unit 3 is provided. The actual curve κ_{act} is fed into the comparison unit 3 by the driving lane recognition system 1. After the collision, no further data is transmitted. The target path is then derived from the saved curve. Furthermore, by way of example, actual values for the vehicle state variables sideslip angle β, vehicle speed Vᵥₑₕ (or, for short, V or v), steering angle δ, yaw rate \dot{Ψ}_{act} and lateral acceleration a_{y} are fed into the comparison unit 3. Using that information, the comparison unit 3 determines a deviation of the yaw angle ΔΨ and a transverse deviation Δy between the actual and target paths, or actual and target values. The deviation of the yaw angle ΔΨ and the transverse deviation Δy are fed into the controller 2 together with the target path (curve κ_{ref}).

The controller 2 is based on a single-lane model of the vehicle in which the yaw moment M_{z}, which results from different brake moments created by the wheel brakes, is taken into account. Furthermore the model treats the prescribed curve κ_{ref} (target path) as a disruption (Z). The model is described by the following state equations:

$$[ \begin{matrix}\dot{β} \\ \ddot{ψ} \\ Δ \dot{ψ} \\ Δ \dot{y}\end{matrix} ] = [ \begin{matrix}- \frac{{C}_{f} + {C}_{r}}{mv} & \frac{- {C}_{f} {l}_{f} + {C}_{r} {l}_{r}}{{mv}^{2}} - 1 & 0 & 0 \\ \frac{{C}_{r} {l}_{r} - {C}_{f} {l}_{f}}{{J}_{z}} & - \frac{{C}_{r} {l}_{r}^{2} + {C}_{f} {l}_{f}^{2}}{{J}_{z}} & 0 & 0 \\ 0 & 1 & 0 & 0 \\ v & 0 & - v & 0\end{matrix} ] \cdot [ \begin{matrix}β \\ \dot{ψ} \\ Δ ψ \\ Δ y\end{matrix} ] + [ \begin{matrix}\frac{{C}_{f}}{mv} & 0 \\ \frac{{C}_{f} {l}_{f}}{{J}_{z}} & \frac{1}{{J}_{z}} \\ 0 & 0 \\ 0 & 0\end{matrix} ] \cdot [ \begin{matrix}δ \\ {M}_{z}\end{matrix} ] + [ \begin{matrix}0 \\ 0 \\ v \\ 0\end{matrix} ] \cdot {κ}_{ref}$$

which is equivalent to \dot{X}=A·X+B·U+W·Z

The task of the controller 2 is to stabilize the vehicle; to this end, the state variables (X) are reduced to zero by steering and/or braking interventions, i.e. sideslip angle β->0, yaw angle deviation ΔΨ->0, and transverse deviation Δy->0.

By way of example, the controller 2 uses the vehicle model to determine a steering angle δ_{req} and a yaw moment M_{z} (control variables U).

By way of example, a steering controller 4 is provided which determines a steering moment δ_{trq} from the steering angle δ_{req}. By way of example, the steering controller 4 is realized as a PID controller (proportional-integral-derivative controller).

Furthermore, by way of example, a brake controller 5 is provided which determines brake pressures Pᵢⱼ for the wheel brakes from the yaw moment M_{z}, so that the yaw moment M_{z} is to be produced by the corresponding braking control.

The steering system and the wheel brakes in the vehicle 6 are controlled in accordance with the steering moment δ_{trq} and the brake pressures Pᵢⱼ.

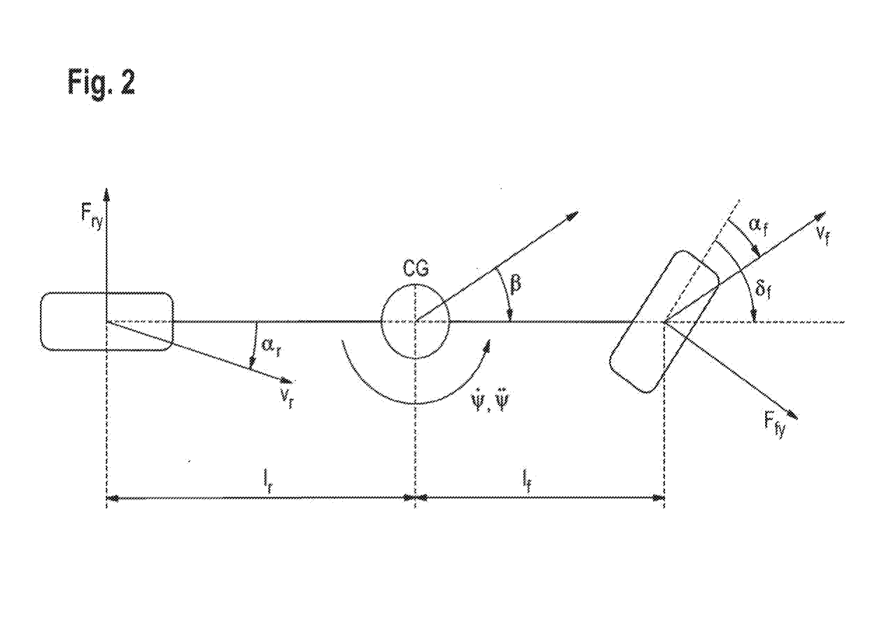

FIG. 2 uses a schematic depiction to illustrate driving state variables for the single-lane model used for lateral control.

The rear lateral force F_{ry}, as well as the rear speed vᵣ and the rear slip angle αᵣ are depicted here on the left-hand side on the rear wheel and the front lateral force F_{ƒy}, as well as the front speed v_{ƒ}, the front slip angle α_{f} and the steering angle δ₇₁ are depicted on the right-hand side on the front wheel. The sideslip angle β, as well as the yaw rate \dot{Ψ} and the yaw acceleration \ddot{Ψ} are plotted around the center of gravity CG which is at a distance l_{f} from the front axle, and at a distance lᵣ from the rear axle.

The disclosure includes a method by which a vehicle is stabilized following a lateral crash, for example with a crash barrier, until the driver is able to steer the vehicle. This means that the vehicle may be in an unstable driving state when the automatic stabilization controller (2, 4, 5) intervenes.

A crash detection may occur when the lateral or longitudinal acceleration sensor exceeds a certain value, which would not occur in an actual driving maneuver (e.g., 2 g), and the slowest driving speed exceeds an appropriate value (e.g., 30 km/h).

Features of the device according to the one exemplary embodiment or the method according to one exemplary embodiment include are:

Firstly, a trajectory planning in which the curve over a distance (approximately 100 m) is determined (for example by a camera or GPS and a road map) before the time of the crash.

At the time of the crash this curve is saved and subsequently driven or controlled until the vehicle is stable (for example, until the sideslip angle is small).

The yaw angle is calculated by integrating the yaw rate.

Secondly, a switchable state controller 2:

A large sideslip angle β produces another assessment of the state variables of the state controller. Where the sideslip angles β are large, driving stability is prioritized, in particular when the sideslip angle exceeds a limit value.

This has the advantage that, where driving states are particularly unstable, a stabilization is brought about as a priority, whilst where driving states are relatively stable, with a sideslip angle β lower than a limit value, guiding the vehicle within the driving lane boundaries may be prioritized.

Where there is a big sideslip angle, a sideslip angle regulation is advantageously implemented.

Thirdly, a control procedure:

After a crash, the vehicle is only stabilized for as long as the driver does not have an overview of the situation or is too confused to suitably control the vehicle (approximately 5 seconds or until the steering angle and steering angle speed are small).

Intervention with braking interventions on individual wheels and steering moment intervention, dividing is effected with the aid of control allocation for actuator potential determination. If the driver does not allow the steering moment, it is set via the brake.

Fourthly, an overlap may be performed with the aid of a multi-collision braking system (“MKB”) known per se:

The MKB functions with a global braking pressure, so that the pressure may preferably be laterally varied for this system without significantly altering the deceleration demanded by the MKB. The MKB decelerates with a maximum of 0.5 g, so that where there is a high friction value for this system, sufficient potential remains for stabilization with steering and brake.

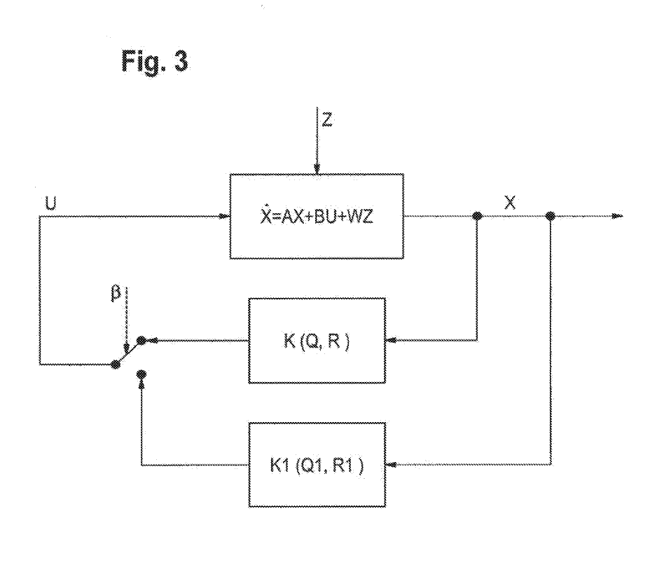

An exemplary switchability of the state controller is depicted in FIG. 3. The controller 2 is based on the state equations already mentioned above in the form \dot{X}=A·X+B·U+W·Z.

In the LQ controller, the state variables X are fed back as input variables (U=−K·X) via a feedback matrix K (or K1). By way of example, two feedback matrixes, K and K1, are provided, wherein the feedback matrix K or the feedback matrix K1 is used for the regulation in accordance with the size of the sideslip angle β.

The feedback matrix K is dependent on a weighting matrix Q for the state variables X, and a weighting matrix R for the control variables U, i.e., K(Q,R). The feedback matrix K1 is correspondingly dependent on a weighting matrix Q1 for the state variables X, and a weighting matrix R1 for the control variables, i.e., K1(Q1,R1).

Accordingly, the controller 2, while controlling, performs a different weighting of the state variables depending on the value of the sideslip angle β, either by means of feedback matrix K or feedback matrix K1.

Advantageously, the sideslip angle β is determined in accordance with the following considerations. Starting with the formula:

a_{y}=\dot{v}_{y}+vₓ\dot{Ψ}

results in:

$$\frac{{a}_{y}}{{v}_{x}} = \frac{{\dot{v}}_{y}}{{v}_{x}} + \dot{ψ}$$

wherein vₓ and v_{y} are the components of the vehicle speed in the x- or y-direction in vehicle coordinates and the derivation of the sideslip angle may be described as

$$\dot{β} = \frac{{\dot{v}}_{y}}{{v}_{x}}$$

so that it follows that:

$$\dot{β} = \frac{{a}_{y}}{{v}_{x}} - \dot{ψ}$$

The sideslip angle β is determined by integration.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

### EXPLANATION OF SYMBOLS

δ, δ_{req} steering angle [wheel]
F_{R}, F_{L} normal force on the left- or right-hand side [N]
δ_{trq} steering moment
α_{y} lateral acceleration of the vehicle [m/s2]
v, v_{act}, Vᵥₑₕ, v speed of the vehicle [m/s]
Ψ yaw angle [wheel]
\dot{Ψ} yaw rate [wheel/s]
\ddot{Ψ} yaw acceleration [wheel/s2]
β sideslip angle [wheel]
\dot{β} sideslip angle speed [wheel/s]
F_{ƒy} front lateral force [N]
F_{ry} rear lateral force [N]
δ_{ƒ} front steering angle [wheel]
α_{f}, αᵣ front and rear slip angle [wheel]
C_{ƒ}, Cᵣ front and rear tyre slip angle stiffness [N/wheel]
M_{z} yaw moment [Nm]
l vehicle wheelbase [m]
lᵣ, l_{ƒ} distance of the rear or front axle from the center of gravity [m]
vᵣ rear speed
v_{ƒ} front speed
m vehicle mass in single-lane model [kg]
CG center of gravity
J_{z} vehicle inertia moment [kg m²]
Δ_{y} transverse deviation (in the y-direction)
ΔΨ deviation of the yaw angle
κ curve of the carriageway
Pᵢⱼ wheel-individual brake pressures
T_{crash} time of collision

What is claimed is:

1. A device for stabilizing a motor vehicle, comprising:
a driving lane recognition system configured to determine or detect the course of a driving lane utilizing information relating to the course of the driving lane;
a collision detection unit configured to identify a collision of the vehicle utilizing signals from at least one sensor or on the basis of a driving state variable;
an electrically controllable steering actuator configured to actuate a steering system;
an electrically controllable brake actuator configured to actuate one or a number of wheel brakes;
a target path determination unit configured to determine a target path for the vehicle on the basis of the course of the driving lane as determined before or at the time of the collision; and
a controller configured to guide the vehicle onto the target path and/or stabilize the vehicle by a steering intervention including actuating the steering system and/or a braking intervention including actuating the brake actuator on individual wheels.

2. The device as claimed in claim 1, wherein a curve in the course of the driving lane is determined or detected as information relating to the course of the driving lane.

3. The device as claimed in claim 1, wherein a deviation of a yaw angle and/or a transverse deviation between actual and target paths or actual and target values is determined in a comparison unit on the basis of the target path and actual values of vehicle state variables.

4. The device as claimed in claim 3, wherein the controller controls a sideslip angle and/or a yaw rate and/or the deviation of the yaw angle and/or the transverse deviation between actual and target paths of the vehicle.

5. The device as claimed in claim 4, wherein that, in order to determine the actual path, the actual value of the sideslip angle (β) and/or a vehicle speed (v, Vᵥₑₕ) and/or a steering angle (δ) and/or the yaw rate (\dot{Ψ}) and/or a lateral acceleration (a_{y}) is taken into account.

6. The device as claimed in claim 4, wherein the actual value of the sideslip angle and/or the yaw angle are determined by integration with the aid of a measured yaw rate, a measured lateral acceleration, and/or a vehicle speed.

7. The device as claimed in claim 4, wherein depending on the actual value of the sideslip angle, the controller weights either the stabilization of the vehicle or the guidance of the vehicle onto the target path more strongly.

8. The device as claimed in claim 4, wherein while controlling, the controller performs a weighting of the state variables in accordance with the actual value of the sideslip angle.

9. The device as claimed in claim 4, wherein the controller carries out a sideslip angle control for sideslip angles which, in absolute terms, are greater than a prescribed sideslip angle limit value, in particular for sideslip angles which, in absolute terms, are greater than approximately 10°.

10. The device as claimed in claim 1, wherein, on identifying a collision of the vehicle, in particular against the lateral carriageway boundary, the course of the driving lane determined or detected is saved as the target path for the vehicle and this target path is made available to the controller as an input value.

11. The device as claimed in claim 1, wherein the controller determines a steering angle and/or a yaw moment by utilizing a vehicle model and the steering intervention, in particular the activation of the steering actuator, and/or the braking interventions on individual wheels, in particular the activation of the brake actuator, occur depending on the steering angle and/or the yaw moment.

12. The device as claimed in claim 11, wherein a steering moment is determined in a steering controller from the steering angle, and that the activation of the steering actuator occurs depending on the steering moment.

13. The device as claimed in claim 11, wherein brake pressures for one or a number of wheel brakes are determined in a brake controller from the yaw moment, and that the activation of the brake actuator occurs depending on the brake pressures.

14. The device as claimed in claim 11, wherein control is brought to an end by the controller if, in absolute terms, the steering angle, in particular for a prescribed time period, falls below a prescribed steering angle threshold value and/or if, in absolute terms, a steering angle speed, in particular for a prescribed time period, falls below a prescribed steering angle speed threshold value.

15. The device as claimed in claim 1, wherein control is brought to an end by the controller if a prescribed time period for the control, in particular approximately 5 sec, has elapsed.

16. The device as claimed in claim 1, wherein the braking interventions on individual wheels are carried out so that a prescribed overall deceleration of the vehicle, in particular an overall declaration of at most approximately 0.5 g, is achieved.

17. A method for stabilizing a vehicle following a collision against a lateral carriageway boundary, comprising:
determining or detecting information relating to a curve in the course of a driving lane;
detecting a collision of the vehicle against the lateral carriageway boundary utilizing signals from at least one sensor or on the basis of a driving state variable;
determining a target path for the vehicle on the basis of the course of the driving lane as determined or detected before or at the time of the collision; and
guiding of the vehicle onto the target path and/or stabilizing of the vehicle, by carrying out a steering intervention and/or braking interventions on individual wheels.
